(19) United States
(12) Patent Application Publication
(10) Pub. No.: US 2020/0294702 A1
(43) Pub. Date: Sep. 17, 2020

(54) METHOD FOR MANUFACTURING POWDER MAGNETIC CORE

(71) Applicant: TOYOTA JIDOSHA KABUSHIKI KAISHA, Toyota-shi (JP)

(72) Inventors: Kohei ISHII, Nagoya-shi (JP); Masaki SUGIYAMA, Miyoshi-shi (JP); Hiroaki HATSUYAMA, Miyoshi-shi (JP)

(73) Assignee: TOYOTA JIDOSHA KABUSHIKI KAISHA, Toyota-shi (JP)

(21) Appl. No.: 16/785,069

(22) Filed: Feb. 7, 2020

(30) Foreign Application Priority Data
Mar. 11, 2019 (JP) 2019-043615

(51) Int. Cl. H01F 27/255; H01F 1/26

(52) U.S. Cl. CPC H01F 27/255; H01F 1/26

(57) ABSTRACT

A method for manufacturing a powder magnetic core according to an aspect includes filling a case with a soft magnetic powder obtained by pulverizing a soft magnetic foil having an amorphous structure or a nanocrystal structure, applying at least one of a vibration and a magnetic field to the soft magnetic powder contained in the case and thereby aligning the soft magnetic powder, and injecting a curable resin into the case, impregnating the aligned soft magnetic powder with the curable resin, and then curing the curable resin while deaerating the curable resin under a reduced pressure.

### CROSS REFERENCE TO RELATED APPLICATIONS

This application is based upon and claims the benefit of priority from Japanese patent application No. 2019-043615, filed on Mar. 11, 2019, the disclosure of which is incorporated herein in its entirety by reference.

### BACKGROUND

The present disclosure relates to a method for manufacturing a powder magnetic core. In particular, the present disclosure relates to a method for manufacturing a powder magnetic core using a soft magnetic powder having an amorphous structure or a nanocrystal structure.

In recent years, soft magnetic powders having an amorphous structure or a nanocrystal structure have been used as raw materials for powder magnetic cores used in, for example, power conversion reactors and the like. In a method for manufacturing a powder magnetic core disclosed in Japanese Unexamined Patent Application Publication No. 2008-294411, a soft magnetic powder obtained by pulverizing a soft magnetic foil having an amorphous structure or a nanocrystal structure is used.

### SUMMARY

Regarding the method for manufacturing a powder magnetic core using a soft magnetic powder having an amorphous structure or a nanocrystal structure, the present inventors have found the following problem.

Since the soft magnetic powder having an amorphous structure or a nanocrystal structure is hard, it is necessary, when the soft magnetic powder is compressed and molded, to perform press forming at a very high pressure (e.g., at about 2 GPa). Further, since a strain (e.g., a deformation) remains in the powder magnetic core due to the press forming performed at the very high pressure, it is necessary to perform annealing for removing the strain after performing the press forming.

The present disclosure has been made in view of the above-described circumstances and an object thereof is to manufacture a powder magnetic core having an excellent magnetic characteristic without using either of press forming and annealing for removing a strain.

A first exemplary aspect is a method for manufacturing a powder magnetic core, including:

filling a case with a soft magnetic powder obtained by pulverizing a soft magnetic foil having an amorphous structure or a nanocrystal structure;

applying at least one of a vibration and a magnetic field to the soft magnetic powder contained in the case and thereby aligning the soft magnetic powder; and

injecting a curable resin into the case, impregnating the aligned soft magnetic powder with the curable resin, and then curing the curable resin while deaerating the curable resin under a reduced pressure.

In the method for manufacturing a powder magnetic core according to an aspect of the present disclosure, after a soft magnetic powder is aligned by applying at least one of a vibration and a magnetic field to the soft magnetic powder, the aligned soft magnetic powder is impregnated with a curable resin and the curable resin is cured while being deaerated under a reduced pressure. Therefore, it is possible to manufacture a powder magnetic core having an excellent magnetic characteristic without using either of press forming and annealing for removing a strain.

In the filling of the case, a coercive force of the prepared soft magnetic powder may be 800 A/m or weaker. By the above-described configuration, it is possible to reduce the hysteresis loss of the manufactured powder magnetic core.

The case may be made of an insulator and the manufactured powder magnetic core may include the case. By the above-described configuration, there is no need to remove the case from the curable resin after the curing and hence the process for manufacturing the powder magnetic core can be simplified.

Prior to the filling of the case, an insulating film may be formed on a surface of the soft magnetic powder by heat-treating the soft magnetic powder after it is pulverized. By the above-described configuration, it is possible to reduce the eddy-current loss of the manufactured powder magnetic core.

In the curing of the curable resin, a carbon nanofiber sheet may be placed above the soft magnetic powder impregnated with the curable resin. By the above-described configuration, it is possible to deaerate the curable resin while preventing the scattering of the curable resin.

The manufactured powder magnetic core may include the carbon nanofiber sheet. By the above-described configuration, there is no need to remove the carbon nanofiber sheet from the curable resin after the curing and hence the process for manufacturing the powder magnetic core can be simplified.

According to the present disclosure, it is possible to manufacture a powder magnetic core having an excellent magnetic characteristic without using either of press forming and annealing for removing a strain.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a flowchart showing a method for manufacturing a powder magnetic core according to a first embodiment;

FIG. 2 is a schematic cross section showing the method for manufacturing a powder magnetic core according to the first embodiment; and

FIG. 3 is a photomicrograph of a cross section of a part of a powder magnetic core manufactured by the method for manufacturing a powder magnetic core according to the first embodiment.

### DESCRIPTION OF EMBODIMENTS

Specific embodiments to which the present disclosure is applied will be described hereinafter in detail with reference to the drawings. However, the present disclosure is not limited to the below-shown embodiments. Further, for clarifying the explanation, the following description and drawings are simplified as appropriate.

### First Embodiment

### <Method for Manufacturing Powder Magnetic Core According to First Embodiment>

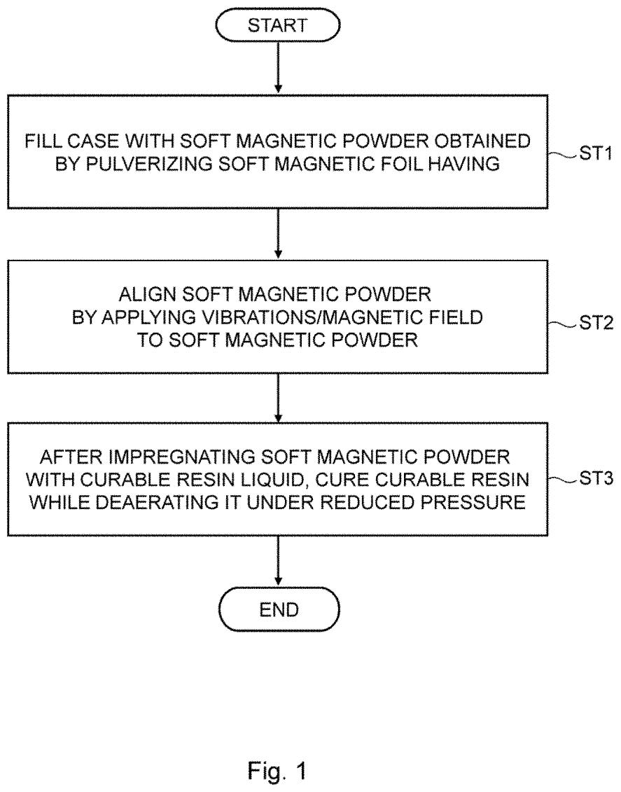

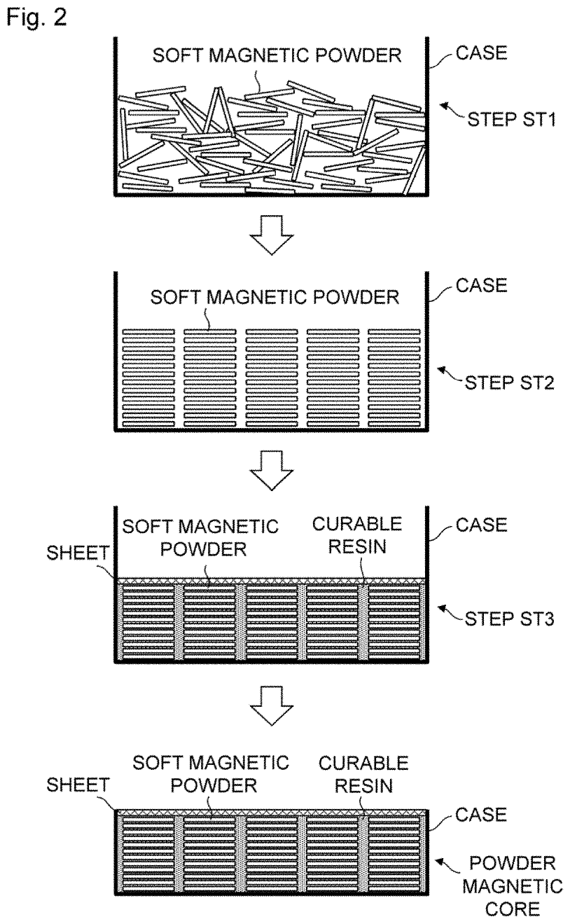

Firstly, a method for manufacturing a powder magnetic core according to a first embodiment will be described with reference to FIGS. 1 and 2. FIG. 1 is a flowchart showing a method for manufacturing a powder magnetic core according to the first embodiment. FIG. 2 is a schematic cross section showing the method for manufacturing a powder magnetic core according to the first embodiment.

Firstly, as shown in FIG. 1, a case is filled with a soft magnetic powder obtained by pulverizing a soft magnetic foil having an amorphous structure or a nanocrystal structure (step ST1). Since this soft magnetic powder is obtained by pulverizing the foil, each particle of the soft magnetic powder has a flat shape. As shown in FIG. 2, the surfaces of the particles of the soft magnetic powder face in random directions in the step ST1.

The soft magnetic powder is not limited to any particular powders as long as it has an amorphous structure or a nanocrystal structure. For example, the soft magnetic powder is composed of an Fe-based amorphous material or an Fe-based nanocrystal material. The thickness of each particle of the soft magnetic powder is, for example, about 5 to 500 μm. Further, the diameter of each particle of the soft magnetic powder is, for example, about 50 to 5,000 μm.

If the particle diameter is too large, the specific resistance decreases or the eddy-current loss increases. Further, if the particle diameter is too small, the coercive force increases and hence, for example, a hysteresis loss increases. Note that the above-described diameter means a grain size (e.g., a grain diameter) that is determined by a sieving method in which particles are classified by using a sieve having a predetermined mesh size. In order to reduce the hysteresis loss of the manufactured powder magnetic core, the coercive force of the soft magnetic powder may be 800 A/m (10 Oe) or weaker.

A method for preparing a soft magnetic powder used in the step ST1 is described hereinafter. Firstly, a heat treatment (an embrittlement process) is performed for a soft magnetic foil at, for example, 200 to 450° C. A soft magnetic powder is obtained by pulverizing the soft magnetic foil, which has been subjected to the embrittlement process, by using, for example, a pulverizer. Because of the embrittlement process, the soft magnetic foil can be easily pulverized.

Further, prior to the step ST1, an insulating film may be formed on the surfaces of particles of the pulverized soft magnetic powder by performing a heat treatment for the soft magnetic powder at 200 to 450° C. For example, an oxide film is formed as the insulating film by performing a heat treatment in an oxidizing atmosphere such as the outside air. The insulating film can reduce the eddy-current loss of the manufactured powder magnetic core.

Next, as shown in FIG. 1, the particles of the soft magnetic powder contained in the case are aligned by applying at least one of vibrations and a magnetic field to the soft magnetic powder (step ST2). As shown in FIG. 2, in a step ST2, the surface of each particle of the soft magnetic powder, which has been aligned in a random direction until then, is aligned in a direction parallel to or close to the horizontal plane by applying vibrations and/or a magnetic field to the soft magnetic powder. By aligning the soft magnetic powder, it is possible to reduce the hysteresis loss of the manufactured powder magnetic core.

Note that either vibrations or a magnetic field may be applied to the soft magnetic powder, or both of them may be applied to the soft magnetic powder. Further, FIG. 2 schematically shows a state in which the particles of the soft magnetic powder are aligned in an ideal fashion.

Next, as shown in FIG. 1, after a curable resin is injected into the case and hence the aligned soft magnetic powder is impregnated with the curable resin liquid, the curable resin is cured while being deaerated under a reduced pressure (step ST3). Since the curable resin is cured while being deaerated under a reduced pressure, the aligned particles of the soft magnetic powder can be integrated with each other while being compressed without using press forming as shown in FIG. 2. There is no particular limitation on the degree of the reduced pressured. That is, it may be any pressure as long as it is lower than the atmospheric pressure.

The curable resin is not limited to any particular resins. Examples of the curable resin include epoxy resins, acrylic resins, and fluoroplastics. Further, in the example shown in FIG. 2, in the step ST3, a sheet is placed on the soft magnetic powder impregnated with the curable resin liquid. Since the sheet is air-permeable, it is possible to deaerate the curable resin while preventing the scattering of the curable resin. The sheet is made of, for example, carbon nanofibers.

Lastly, as shown in FIG. 2, a powder magnetic core is obtained by removing an upper part of the case. The case is made of, for example, an insulator. As shown in FIG. 2, the manufactured powder magnetic core may include the case and/or the sheet. By using the insulating case and/or the carbon nanofiber sheet, there is no need to remove the case and/or the sheet from the curable resin after the curing as shown in FIG. 2. As a result, the process for manufacturing the powder magnetic core can be simplified.

In the method for manufacturing a powder magnetic core according to the first embodiment, after a soft magnetic powder is aligned by applying at least one of vibrations and a magnetic field (step ST2), the soft magnetic powder is impregnated with a curable resin liquid and the curable resin is cured while being deaerated under a reduced pressure (step ST3). As described above, in the method for manufacturing a powder magnetic core according to the first embodiment, it is possible to manufacture a powder magnetic core having an excellent magnetic characteristic without using either of press forming and annealing for removing a strain.

### Example

A powder magnetic core and a method for manufacturing the same according to the first embodiment will be described hereinafter in a more detailed manner by showing an example and a comparative example. However, the powder magnetic core and the method for manufacturing the same according to the first embodiment are not limited to the below-shown examples.

### Example

Firstly, a heat treatment (an embrittlement process) was performed for an amorphous soft magnetic foil (MetglasR 2605HB1M manufactured by Hitachi Metals, Ltd.) at 360° C. A soft magnetic powder having an average particle diameter of 500 μm was obtained by pulverizing the soft magnetic foil, which had been subjected to the embrittlement process, by using a pulverizer (Feather Mill (Registered Trademark) manufactured by Hosokawa Micron Corporation). An insulating oxide film was formed on the surfaces of particles of the soft magnetic powder by performing a heat treatment for the soft magnetic powder at 300° C. in the atmospheric atmosphere. The coercive force of the soft magnetic powder was measured by using a coercive force measuring device (VSM manufactured by Toyo Technica Inc.) and the measured coercive force was 20 A/m (0.25 Oe).

A case made of an insulator was filled with the soft magnetic powder. Next, the particles of the soft magnetic powder contained in the case were aligned by applying vibrations to the soft magnetic powder by using a vibrator. Then, after an epoxy resin was injected into the case and hence the aligned soft magnetic powder was impregnated with the epoxy resin liquid, the curable resin was cured while being deaerated under a reduced pressure. As a result, a powder magnetic core was produced.

### Comparative Example

The surfaces of particles of the soft magnetic powder used in the above-described example, on which the insulating oxide film had already been formed, were coated with a silicone resin. A powder magnetic core was produced by first performing press forming for the soft magnetic powder at 1,600 MPa (1.6 GPa) and then performing annealing for removing a strain at 450° C.

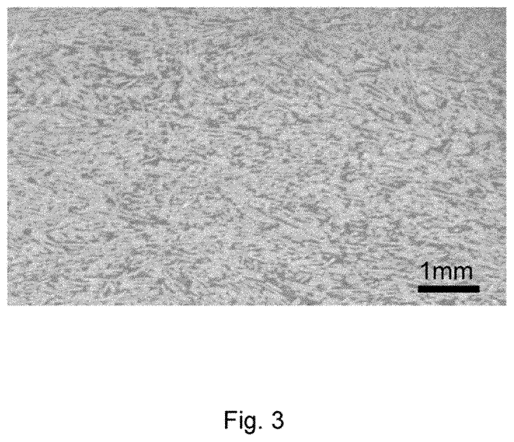

Next, test results will be described. Table 1 shows test results of the example according to the first embodiment and those of the comparative example. Table 1 shows densities [g/cm³], losses [kW/m³], and strengths [MPa]. Further, FIG. 3 is a photomicrograph of a cross section of a part of a powder magnetic core (the example) manufactured by the method for manufacturing a powder magnetic core according to the first embodiment.

TABLE 1

| | Density | Loss | Strength |
|---|---|---|---|
| | [g/cm³] | [W/m³] | [MPa] |
| Comparative | 4.8 | 250 | 10 |
| Example | | | |
| Example | 4.8 | 230 | 100 |

As shown in Table 1, in the powder magnetic core according to the example, a density comparable to that of the comparative example was obtained by curing the curable resin while deaerating it under a reduced pressure without using either of press forming and annealing for removing a strain. Further, in the powder magnetic core according to the example, since the soft magnetic powder was aligned by applying vibrations, the loss was successfully reduced as compared to that in the comparative example. Further, in the powder magnetic core according to the example, a strength ten times larger than that of the comparative example was successfully achieved by using a thermosetting resin.

In FIG. 3, white parts are the soft magnetic powder and black parts are the curable resin. As shown in FIG. 3, in the powder magnetic core according to the example, high-density particles of the soft magnetic powder were bonded to each other by the thermosetting resin in a state where the particles were aligned.

As described above, by the method for manufacturing a powder magnetic core according to the first embodiment, a powder magnetic core having an excellent magnetic characteristic and an excellent strength was successfully manufactured without using either of press forming and annealing for removing a strain.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a powder magnetic core, comprising:
filling a case with a soft magnetic powder obtained by pulverizing a soft magnetic foil having an amorphous structure or a nanocrystal structure;
applying at least one of a vibration and a magnetic field to the soft magnetic powder contained in the case and thereby aligning the soft magnetic powder; and
injecting a curable resin into the case, impregnating the aligned soft magnetic powder with the curable resin, and then curing the curable resin while deaerating the curable resin under a reduced pressure.

2. The method for manufacturing a powder magnetic core according to claim 1, wherein in the filling of the case, a coercive force of the prepared soft magnetic powder is 800 A/m or weaker.

3. The method for manufacturing a powder magnetic core according to claim 1, wherein the case is made of an insulator and the manufactured powder magnetic core includes the case.

4. The method for manufacturing a powder magnetic core according to claim 1, wherein prior to the filling of the case, an insulating film is formed on a surface of the soft magnetic powder by heat-treating the soft magnetic powder after it is pulverized.

5. The method for manufacturing a powder magnetic core according to claim 1, wherein in the curing of the curable resin, a carbon nanofiber sheet is placed above the soft magnetic powder impregnated with the curable resin.

6. The method for manufacturing a powder magnetic core according to claim 5, wherein the manufactured powder magnetic core includes the carbon nanofiber sheet.
